(19) United States
(12) Patent Application Publication
(10) Pub. No.: US 2025/0030033 A1
(43) Pub. Date: Jan. 23, 2025

(54) BATTERY CELL AND BATTERY MODULE

(71) Applicant: TOYOTA JIDOSHA KABUSHIKI KAISHA, Toyota-shi (JP)

(72) Inventors: Masato ONO, Nagoya-shi (JP); Shintaro UTSUMI, Susono-shi (JP); Kazuhito KATO, Toyota-shi (JP); Yusuke KINTSU, Miyoshi-shi (JP); Atsushi YAMANAKA, Nagoya-shi (JP); Takaaki GOTO, Seto-shi (JP); Hiroki AWANO, Susono-shi (JP)

(73) Assignee: TOYOTA JIDOSHA KABUSHIKI KAISHA, Toyota-shi (JP)

(21) Appl. No.: 18/679,925

(22) Filed: May 31, 2024

(30) Foreign Application Priority Data
Jul. 18, 2023 (JP) 2023-117150

(51) Int. Cl. H01M 10/04; H01M 50/105; H01M 50/211; H01M 50/249

(52) U.S. Cl. CPC H01M 10/0413; H01M 50/105; H01M 50/211; H01M 50/249

(57) ABSTRACT

A battery cell includes: an electrode body including plural layered structures, each including a positive electrode, a negative electrode, and a separator disposed between the positive electrode and the negative electrode; and a battery cell case that hermetically encloses the electrode body inside the battery cell case. At least one of the current collector in the positive electrode or the current collector in the negative electrode has, on a peripheral portion of a surface thereof, an uncoated portion at which the mix is not coated. A current collector of which the distance from the surface of the battery cell case is the greatest among current collectors each having an uncoated portion has a first uncoated portion, and the first uncoated portion extends to the outside of the battery cell case, thereby forming a first exposed portion.

### CROSS-REFERENCE TO RELATED APPLICATION

This application is based on and claims priority under 35 USC 119 from Japanese Patent Application No. 2023-117150, filed on Jul. 18, 2023, the disclosure of which is incorporated by reference herein.

### BACKGROUND

### Technical Field

The present disclosure relates to a battery cell and a battery module.

### Related Art

Battery cells including an electrode body, in which plural positive electrodes, negative electrodes, and separators are layered, and a battery cell case that seals the electrode body inside have conventionally been used.

For example, Japanese National Publication No. 2015-522912 discloses a battery cell where a member for dissipating heat generated by the electrode body (e.g., heat generated during charging and discharging and when a short-circuit occurs) is installed inside the electrode body and where part of the heat dissipation member is exposed to the outside.

Furthermore, International Publication No. 2013/027306 discloses a battery cell with a structure where current collectors disposed near a battery cell case extend to the outside.

### SUMMARY

The battery cell disclosed in Japanese National Publication No. 2015-522912 has a structure that dissipates the heat generated by the electrode body by exposing the heat dissipation member to the outside of the battery cell. Furthermore, International Publication No. 2013/027306 forms a path for dissipating the heat from the electrode body by extending current collectors to the outside of the battery cell.

However, a structure that can more efficiently dissipate heat is desired.

The present disclosure has been devised in view of the above circumstances, and it is an object thereof to provide a battery cell that can efficiently dissipate heat generated by an electrode body and a battery module including the battery cell.

Aspects according to the present disclosure includes the following aspects.
<1> A battery cell, including:
an electrode body including plural layered structures layered one on another, each including a positive electrode, a negative electrode, and a separator disposed between the positive electrode and the negative electrode; and
a battery cell case that hermetically encloses the electrode body inside the battery cell case,
wherein:
each of the positive electrode and the negative electrode includes a current collector and a mix that includes an active material and that is coated on a surface of the current collector,
at least one of the current collector in the positive electrode or the current collector in the negative electrode has, on a peripheral portion of a surface thereof, an uncoated portion at which the mix is not coated, and
a current collector of which the distance from the surface of the battery cell case is the greatest among current collectors each having an uncoated portion has a first uncoated portion, and the first uncoated portion extends to the outside of the battery cell case, thereby forming a first exposed portion.
<2> The battery cell of <1>, wherein the shape of an electrode face of the electrode body is rectangular, and the first exposed portion is disposed at a side along a long side of the rectangular shape.
<3> The battery cell of <1> or <2>, wherein the shape of an electrode face of the electrode body is rectangular, and the first exposed portion is provided at either a positive electrode or a negative electrode of which a length of a long side of a rectangular shape thereof is the greater.
<4> The battery cell of any one of <1> to <3>, wherein a current collector of which the distance from the surface of the battery cell case is smaller than the distance of the current collector having the first uncoated portion has a second uncoated portion, and the second uncoated portion extends to the outside of the battery cell case, thereby forming a second exposed portion.
<5> The battery cell of <4>, wherein the battery cell has, inside the battery cell case, a site at which the first uncoated portion and the second uncoated portion are joined.
<6> The battery cell of <4> or <5>, wherein the thickness of the first uncoated portion is greater than the thickness of the second uncoated portion.
<7> A battery module, including:
the battery cell of any one of <1> to <6>; and
at least one of a condenser or a battery module case,
wherein the first exposed portion is joined to at least one of the condenser or the battery module case in an electrically insulating manner.

According to the present disclosure, there can be provided a battery cell that can efficiently dissipate heat generated by an electrode body and a battery module including the battery cell.

### BRIEF DESCRIPTION OF THE DRAWINGS

FIG. 1 is schematic cross-sectional view exemplifying a battery cell according to an embodiment of the present disclosure;

FIG. 2 is a schematic perspective view showing an electrode body in the battery cell according to the embodiment of the present disclosure;

FIG. 3 is a schematic cross-sectional view exemplifying another aspect of the battery cell according to the embodiment of the present disclosure;

FIG. 4 is a schematic plan view showing main parts of a vehicle;

FIG. 5 is a schematic perspective view of a battery module;

FIG. 6 is a plan view of the battery module a state in which a top cover is removed; and

FIG. 7 is a schematic view of the battery cell housed in the battery module as seen from its thickness direction.

### DETAILED DESCRIPTION

### Battery Cell

A battery cell according to an embodiment of the present disclosure includes an electrode body that includes plural layered structures layered one on another, each including a positive electrode, a negative electrode and a separator disposed between the positive electrode and the negative electrode, and a battery cell case that hermetically encloses the electrode body inside the battery cell case. Each of the positive electrode and the negative electrode includes a current collector and a mix that includes an active material and that is coated on a surface of the current collector. Moreover, at least one of the current collector in the positive electrode or the current collector in the negative electrode has, on a peripheral portion of a surface thereof, an uncoated portion at which the mix is not coated.

Additionally, the uncoated portion of a current collector of which the distance from the surface of the battery cell case is the greatest among current collectors each having an uncoated portion is designated as a first uncoated portion, and the first uncoated portion extends to the outside of the battery cell case, thereby forming a first exposed portion. It will be noted that the current collector of which the distance from the surface of the battery cell case is the greatest among current collectors each having an uncoated portion refers to the current collector that is, in a stacked electrode body for example, closest to the center of the electrode body in the stack direction of the electrode body.

An embodiment of the battery cell according to the embodiment of the present disclosure will be described below using the drawings.

Each of the drawings discussed below is schematically rendered, and sizes and shapes of parts shown in the drawings are exaggerated as appropriate to facilitate understanding. Throughout the drawings, corresponding members are denoted by the same reference character, and overlapping descriptions thereof may be omitted, as appropriate.

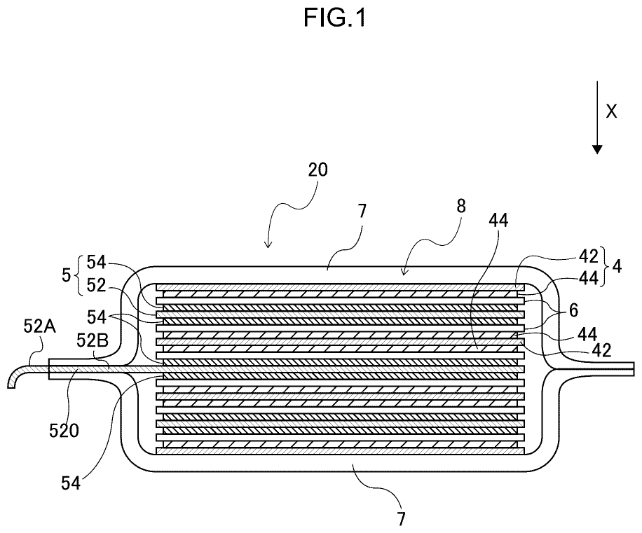

FIG. 1 is a schematic cross-sectional view exemplifying the battery cell according to an embodiment of the present disclosure.

A battery cell 20 shown in FIG. 1 includes positive electrodes 4, negative electrodes 5, and separators 6 disposed between the positive electrodes 4 and the negative electrodes 5. Plural layered structures, each including a positive electrode 4, a negative electrode 5, and a separator 6, are layered one on another to configure an electrode body 8. The positive electrodes 4 each include a positive electrode current collector 42 and a positive electrode mix 44 that includes an active material and that is coated on a surface of the positive electrode current collector 42. The negative electrodes 5 each include a negative electrode current collector 52 and a negative electrode mix 54 that includes an active material and that is coated on a surface of the negative electrode current collector 52. It will be noted that in the electrode body 8 shown in FIG. 1, next to a structure in which a positive electrode 4, a separator 6, and a negative electrode 5 are layered in this order, a structure in which a negative electrode 5, a separator 6, and a positive electrode 4 are layered in this order is disposed. Namely, the negative electrodes 5 are adjacent to each other, and the adjacent negative electrodes 5 share a negative electrode current collector 52. Likewise, next to a structure in which a negative electrode 5, a separator 6, and a positive electrode 4 are layered in this order, a structure in which a positive electrode 4, a separator 6, and a negative electrode 5 are layered in this order is disposed. Namely, the positive electrodes 4 are adjacent to each other, and the adjacent positive electrodes 4 share a positive electrode current collector 42. Consequently, the electrode body 8 shown in FIG. 1 is, starting at the top, a layer stack in the order of “positive electrode current collector 42, positive electrode mix 44, separator 6, negative electrode mix 54, negative electrode current collector 52, negative electrode mix 54, separator 6, positive electrode mix 44, positive electrode current collector 42, positive electrode mix 44, separator 6, negative electrode mix 54, negative electrode current collector 52, negative electrode mix 54, . . . , positive electrode current collector 42.”

The battery cell 20 includes a battery cell case 7 that hermetically encloses the electrode body 8 inside the battery cell case 7. The battery cell case 7 includes two films of which end portions are fused together to form a housing portion that hermetically encloses the electrode body 8 inside.

The positive electrode current collectors 42 of the positive electrodes 4 have, at peripheral portions of their surfaces, uncoated portions at which the positive electrode mix 44 is not coated. Likewise, the negative electrode current collectors 52 of the negative electrodes 5 have, at peripheral portions of their surfaces, uncoated portions at which the negative electrode mix 54 is not coated. An uncoated portion (hereinafter referred to as a “first uncoated portion”) 52B of a negative electrode current collector 520 corresponding to the current collector of which the distance from the surface of the battery cell case 7 is the greatest among the current collectors having the uncoated portions extends to the outside of the battery cell case 7, thereby forming a first exposed portion 52A exposed from the battery cell case 7. Namely, the first uncoated portion 52B of the negative electrode current collector 520 continues to the first exposed portion 52A disposed outside the battery cell case 7. The distal end of the first exposed portion 52A is formed in a curved shape. The negative electrode current collector 520 including the first exposed portion 52A is the current collector that is closest to the center of the electrode body 8 in the layer-stack direction of the electrode body 8 (the direction of arrow X in FIG. 1).

The battery cell according to the embodiment of the present disclosure can, by virtue of having the above configuration, efficiently dissipate heat generated by the electrode body.

An electrode body generates heat during charging and discharging and when a short-circuit occurs. To dissipate the heat generated by the electrode body, conventionally, for example, a structure that dissipates the heat generated by the electrode body by exposing a heat dissipation member to the outside of the battery cell has been employed, or a current collector nearest to a battery cell case among multiple current collectors has been extended to the outside of the battery cell to form a path for dissipating the heat from the electrode body. However, in the former case there is the concern that, due to the joint state between the electrode body and the heat dissipation member, the thermal conduction at the joint site will become a rate determining process, and in the latter case there is the concern that a rate determining process will arise on a route of heat dissipation from the central portion of an electrode body with a layered structure. For that reason, more efficient dissipation of the heat generated by the electrode body is desired.

To address this, the battery cell according to the embodiment of the present disclosure is given a structure in which current collectors having uncoated portions are provided in the electrode body housed inside the battery cell, and uses as a heat dissipation member the current collector that is farthest from the surface of the battery cell case among the current collectors having the uncoated portions. For that reason, in the electrode body that is a heat source, the current collector disposed in the center portion having particularly high tendency toward heat accumulation is used as the heat dissipation member. Because of this, the heat can be smoothly dissipated without a rate determining process of thermal conduction, and the heat generated by the electrode body can be efficiently dissipated.

Furthermore, the battery cell does not use a separate dedicated member for heat dissipation, which leads to a reduction in the number of parts.

### Position of First Exposed Portion

When the shape of an electrode face of the electrode body is rectangular, the first exposed portion is preferably disposed at a side along a long side of the rectangular shape.

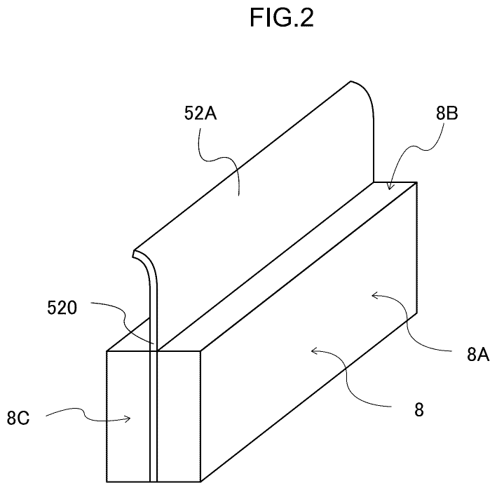

Namely, as shown in FIG. 2, when the electrode body 8 is substantially in the shape of a rectangular cuboid and the shape of its electrode face 8A is rectangular, the first exposed portion 52A of the current collector 520 is preferably disposed at a face 8B on a long side and not at a face 8C on a short side of the rectangular shape of the electrode face 8A. It will be noted that in FIG. 2 illustration of the positive electrode current collectors, the positive electrode mix, the negative electrode current collectors, the negative electrode mix, and the separators configuring the electrode body 8 is omitted, and aside from showing the current collector 520 having the first exposed portion 52A, FIG. 2 simply depicts the electrode body 8 without further details.

Because the battery cell has this configuration, the distance between the center portion of the electrode body, which has high tendency toward heat accumulation, and the first exposed portion can be reduced and the cross-sectional area of the heat dissipation path can be increased, so the heat generated by the electrode body can be more efficiently dissipated.

### Electrode Provided With First Exposed Portion

When the shape of the electrode face of the electrode body is rectangular, the first exposed portion is preferably provided at either a positive electrode or a negative electrode of which a length of a long side of a rectangular shape thereof is the greater. Because of this, the cross-sectional area of the heat dissipation path can be increased, so the heat generated by the electrode body can be more efficiently dissipated. It will be noted that the electrode of which the length of the long side of the rectangular shape thereof is the greater among the positive electrode and the negative electrode is preferably a negative electrode.

### Second Exposed Portion

Although FIG. 1 shows an aspect in which the uncoated portions of the current collectors have only one exposed portion that extends to the outside of the battery cell case, possible aspects are not limited to this and the uncoated portions may have two or more exposed portions.

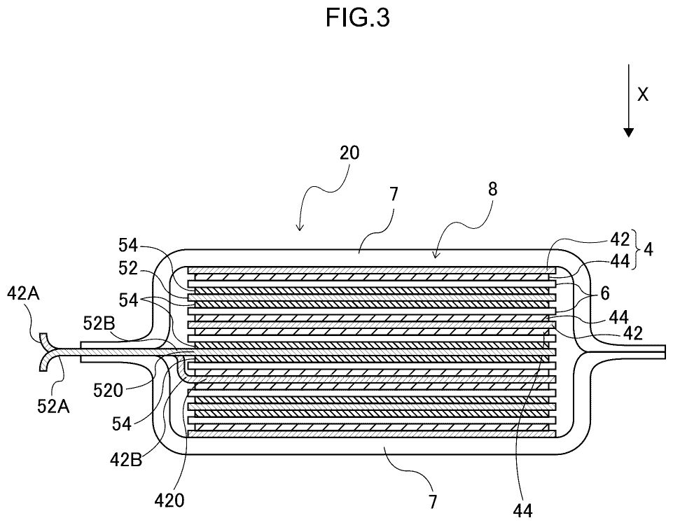

Here, an aspect in which two exposed portions are provided will be described using FIG. 3.

FIG. 3 is a schematic cross-sectional view exemplifying another aspect of the battery cell according to an embodiment of the present disclosure.

In a battery cell 20 shown in FIG. 3, a first uncoated portion 52B of a negative electrode current collector 520 corresponding to the current collector of which the distance from the surface of a battery cell case 7 is the greatest among current collectors having uncoated portions extends to the outside of the battery cell case 7, thereby forming a first exposed portion 52A that is exposed from the battery cell case 7. Furthermore, an uncoated portion (hereinafter referred to as a “second uncoated portion”) 42B of a positive electrode current collector 420 of which the distance from the surface of the battery cell case 7 is smaller than the distance of the negative electrode current collector 520 having the first exposed portion 52A extends to the outside of the battery cell case 7, thereby forming a second exposed portion 42A. Namely, the first uncoated portion 52B of the negative electrode current collector 520 continues to the first exposed portion 52A disposed outside the battery cell case 7, and the second uncoated portion 42B of the positive electrode current collector 420 continues to the second exposed portion 42A disposed outside the battery cell case 7. The distal ends of the first exposed portion 52A and the second exposed portion 42A are both formed in curved shapes.

The negative electrode current collector 520 including the first exposed portion 52A is the current collector that is closest to the center of the electrode body 8 in the layer-stack direction of the electrode body 8. The positive electrode current collector 420 including the second exposed portion 42A is a current collector that is farther than the negative electrode current collector 520 from the center of the electrode body 8 in the layer-stack direction of the electrode body 8.

Because the battery cell has this configuration, the cross-sectional area of the heat dissipation path can be increased, so the heat generated by the electrode body can be more efficiently dissipated.

It will be noted that the second uncoated portion is preferably joined to the first uncoated portion inside the battery cell case. When the battery cell has, inside the battery cell case, a site at which the first uncoated portion and the second uncoated portion are joined, the heat from the entire layered electrode body can be efficiently dissipated.

Furthermore, the thickness of the first uncoated portion (in FIG. 3, the thickness of the uncoated portion 52B of the negative electrode current collector 520) is preferably greater than the thickness of the second uncoated portion (in FIG. 3, the thickness of the uncoated portion 42B of the positive electrode current collector 420). It will be noted that “thickness” refers to the average thickness and means the arithmetic mean value of thicknesses at ten freely-selected positions in the relevant portion.

When the thickness of the first uncoated portion is the greater, heat dissipation from the center portion having a high tendency toward heat accumulation can be preferentially performed.

In the battery cell 20 shown in FIG. 1, the first uncoated portion 52B of the negative electrode current collector 520 extends to pass through a fused portion at which the end portions of the two films are fused together, and is exposed to the outside. Furthermore, in the battery cell 20 shown in FIG. 3, the first uncoated portion 52B of the negative electrode current collector 520 and the second uncoated portion 42B of the positive electrode current collector 420 extend to pass through a fused portion at which the end portions of the two films are fused together, and are exposed to the outside. It will be noted that at a region of the fused portion at which the uncoated portion or uncoated portions are present, the current collector or current collectors are present between the two films, and tightly attach to the two films. Surfaces of the first uncoated portion 52B and the second uncoated portion 42B at a region at which the first uncoated portion 52B and the second uncoated portion 42B pass through the fused portion of the battery cell case 7 have preferably been subjected to at least one of a roughening treatment or a carbon coating treatment from the standpoint of enhancing fusibility and scalability.

It will be noted that although FIG. 1 and FIG. 3 show aspects of a stacked electrode body, the battery cell according to embodiments of the present disclosure is not limited to these aspects. For example, the battery cell may have the structure of a coiled electrode body cell including a coiled electrode body inside.

Next, a battery module, a battery pack, and a vehicle that have the battery cell according to embodiments of the present disclosure will be described using the drawings.

### Overall Configuration of Vehicle 100

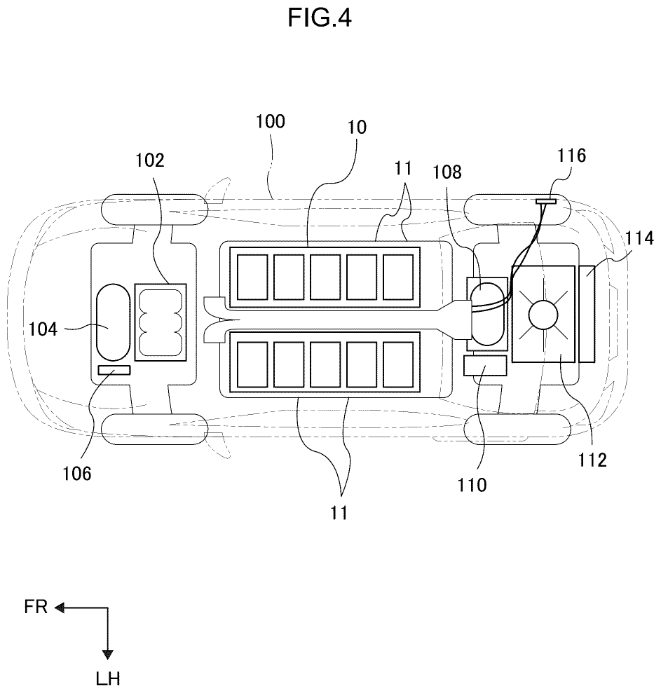

FIG. 4 is a schematic plan view showing main parts of a vehicle 100 to which a battery pack 10 according to an embodiment has been applied. As shown in FIG. 4, the vehicle 100 is a battery electric vehicle (BEV) in which the battery pack 10 is installed under the floor. It will be noted that arrow UP, arrow FR, and arrow LH in the drawings indicate an upward direction in the vehicle up and down direction, a forward direction in the vehicle front and rear direction, and a leftward direction in the vehicle width direction, respectively. When description is given using the directions of front/rear, left/right, and upper/lower, unless otherwise specified these shall mean front/rear in the vehicle front and rear direction, left/right in the vehicle width direction, and upper/lower in the vehicle up and down direction.

In the vehicle 100 of the present embodiment, as an example, a DC/DC converter 102, an electric compressor 104, and a positive temperature coefficient (PTC) heater 106 are disposed on the vehicle front side of the battery pack 10. Furthermore, a motor 108, a gearbox 110, an inverter 112, and a charger 114 are disposed on the vehicle rear side of the battery pack 10.

Direct current output from the battery pack 10 has its voltage regulated by the DC/DC converter 102 and is thereafter supplied to the electric compressor 104, the PTC heater 106, the inverter 112, and elsewhere. Furthermore, power is supplied via the inverter 112 to the motor 108, whereby rear wheels rotate and cause the vehicle 100 to travel.

A charging port 116 is provided in the right side portion of the rear portion of the vehicle 100. By connecting a charging plug of an outside charging station (not shown in the drawings) to the charging port 116, power can be stored in the battery pack 10 via the on-board charger 114.

It will be noted that the arrangement and structures of the parts configuring the vehicle 100 are not limited to the configurations described above. For example, the battery pack 10 may also be applied to a hybrid vehicle (HV) or a plug-in hybrid electric vehicle (PHEV) in which an engine is installed. Furthermore, in the present embodiment, the vehicle to which the battery pack 10 is applied is a rear-wheel-drive vehicle in which the motor 108 is installed in the rear portion of the vehicle, but the vehicle to which the battery pack 10 is applied is not limited to this and may be a front-wheel-drive vehicle in which the motor 108 is installed in the front portion of the vehicle or a vehicle in which a pair of the motors 108 are installed in the front and rear of the vehicle. Moreover, the vehicle to which the battery pack 10 is applied may be a vehicle in which each wheel has an in-wheel motor.

Here, the battery pack 10 includes plural battery modules 11. In the present embodiment, as an example, the battery pack 10 is provided with ten battery modules 11. Specifically, five battery modules 11 are arrayed in the vehicle front and rear direction on the right side of the vehicle 100, and five battery modules 11 are arrayed in the vehicle front and rear direction on the left side of the vehicle 100. Furthermore, the battery modules 11 are electrically interconnected.

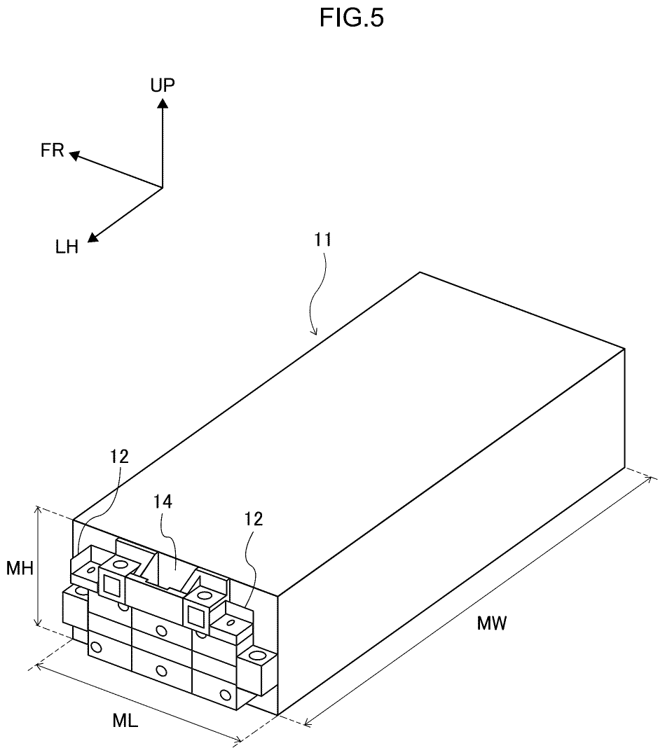

FIG. 5 is a schematic perspective view of the battery module 11. As shown in FIG. 5, the battery module 11 is formed substantially in the shape of a rectangular cuboid of which lengthwise direction coincides with the vehicle width direction. Furthermore, a shell of the battery module 11 is formed of an aluminum alloy. For example, the shell of the battery module 11 is formed by joining, by means of laser welding or the like, aluminum die-cast products to both end portions of an extruded material of aluminum alloy.

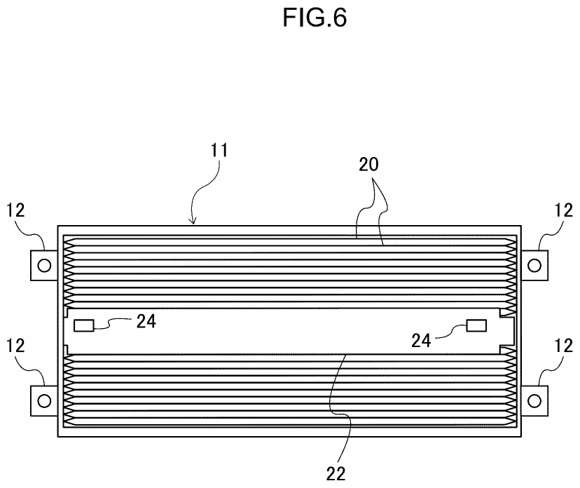

Both vehicle width direction end portions of the battery module 11 are provided with a pair of voltage terminals 12 and a connector 14. A flexible printed circuit 22 (further detailed in FIG. 6) is connected to the connector 14. Furthermore, busbars (not shown in the drawings) are welded to both vehicle width direction end portions of the battery module 11.

The battery module 11 has a vehicle width direction length MW that is, for example, 350 mm to 600 mm, a vehicle front and rear direction length ML that is, for example, 150 mm to 250 mm, and a vehicle up and down direction height MH that is, for example, 80 mm to 110 mm.

FIG. 6 is a plan view of the battery module 11 in a state in which a top cover is removed. As shown in FIG. 6, inside the battery module 11 plural battery cells 20 are housed in an arrayed state. In the present embodiment, as an example, twenty-four battery cells 20 are arrayed in the front and rear direction of the vehicle and adhered to each other.

On or above the battery cells 20 is disposed a flexible printed circuit (FPC) 22. The flexible printed circuit 22 is formed in the shape of a band of which lengthwise direction coincides with the vehicle width direction, and thermistors 24 are provided on both end portions of the flexible printed circuit 22. The thermistors 24 are not adhered to the battery cells 20 but are configured to be pressed toward the battery cells 20 by the top cover of the battery module 11.

Furthermore, inside the battery module 11, one or plural cushioning members (not shown in the drawings) are housed. For example, the cushioning members are elastically deformable laminar members and are disposed between adjacent battery cells 20 in such a way that their thickness direction coincides with the array direction of the battery cells 20. In the present embodiment, as an example, the cushioning members are disposed at both lengthwise direction end portions and the lengthwise direction central portion of the battery module 11.

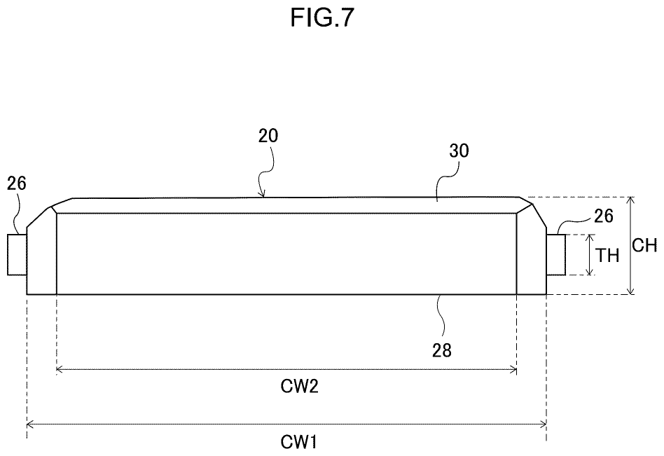

FIG. 7 is a schematic view of the battery cell 20 housed in the battery module 11 as seen from its thickness direction. As shown in FIG. 7, the battery cell 20 is formed substantially in the shape of a rectangular plate, and an electrode body (not shown in the drawings) is housed inside the battery cell 20. The electrode body is configured by layering positive electrodes, negative electrodes, and separators and is hermetically enclosed by a laminate film 28.

In the present embodiment, as an example, a housing portion for the electrode body is formed by folding over and bonding the laminate film 28 that is sheet-shaped and embossed. It will be noted that although a single cup embossed structure that is embossed in one place and a double cup embossed structure that is embossed in two places can be employed, in the present embodiment a single cup embossed structure with a draw depth of about 8 mm to 10 mm is employed.

The upper ends of both lengthwise direction end portions of the battery cell 20 are bent, and the corners form parts of the outline of the battery cell 20. Furthermore, the upper end portion of the battery cell 20 is bent, and a fixing tape 30 is wrapped along the lengthwise direction around the upper end portion of the battery cell 20.

Here, both lengthwise direction end portions of the battery cell 20 are each provided with a terminal (tab) 26. In the present embodiment, as an example, the terminals 26 are provided in positions downwardly offset from the up and down direction center of the battery cell 20. The terminals 26 are joined by laser welding or the like to busbars (not shown in the drawings).

A vehicle width direction length CW1 of the battery cell 20 is, for example, 530 mm to 600 mm, a length CW2 of the region at which the electrode body is housed is, for example, 500 mm to 520 mm, and a height CH of the battery cell 20 is, for example, 80 mm to 110 mm. Furthermore, the thickness of the battery cell 20 is, for example, 7.0 mm to 9.0 mm, and a height TH of the terminals 26 is, for example, 40 mm to 50 mm.

### Module Case of Battery Module

It will be noted that the battery module may further be housed in a battery module case. In this case, the first exposed portions (preferably, the first exposed portions and the second exposed portions, and more preferably all the exposed portions) in the battery cells are preferably joined to the battery module case in an electrically insulating manner. By joining the exposed portions to the battery module case in an electrically insulating manner, the heat generated by the electrode bodies can be more efficiently dissipated.

### Condenser for Battery Module

The battery module may further include a condenser. In this case, the first exposed portions (preferably, the first exposed portions and the second exposed portions, and more preferably all the exposed portions) in the battery cells are preferably joined to the condenser in an electrically insulating manner. By joining the exposed portions to the condenser in an electrically insulating manner, the heat generated by the electrode bodies can be more efficiently dissipated.

It will be noted that examples of aspects of insulation joints include potting and joints using alumina.

The respective reference characters in the drawings designate the following elements.
4: Positive Electrode
42 and 420: Positive Electrode Current Collector
42A: Second Exposed Portion
44: Positive Electrode Mix
5: Negative Electrode
52 and 520: Negative Electrode Current Collector
52A: First Exposed Portion
54: Negative Electrode Mix
6: Separator
7: Battery Cell Case
8: Electrode Body
10: Battery Pack
11: Battery Module
12: Voltage Terminal
14: Connector
20: Battery Cell
22: Flexible Print Circuit
24: Thermistor
26: Terminal
28: Laminate Film
30: Fixing Tape
100: Vehicle
102: Converter
104: Electric Compressor
106: Heater
108: Motor
110: Gear Box
112: Inverter
114: On-board Charger
116: Charging Port

What is claimed is:

1. A battery cell, comprising:
an electrode body including a plurality of layered structures layered one on another, each including a positive electrode, a negative electrode, and a separator disposed between the positive electrode and the negative electrode; and
a battery cell case that hermetically encloses the electrode body inside the battery cell case,
wherein:
each of the positive electrode and the negative electrode includes a current collector and a mix that includes an active material and that is coated on a surface of the current collector,
at least one of the current collector in the positive electrode or the current collector in the negative electrode has, on a peripheral portion of a surface thereof, an uncoated portion at which the mix is not coated, and
a current collector of which a distance from a surface of the battery cell case is greatest among current collectors each having an uncoated portion has a first uncoated portion, and the first uncoated portion extends to outside of the battery cell case, thereby forming a first exposed portion.

2. The battery cell of claim 1, wherein a shape of an electrode face of the electrode body is rectangular, and the first exposed portion is disposed at a side along a long side of the rectangular shape.

3. The battery cell of claim 1, wherein a shape of an electrode face of the electrode body is rectangular, and the first exposed portion is provided at either a positive electrode or a negative electrode of which a length of a long side of a rectangular shape thereof is greater.

4. The battery cell of claim 1, wherein a current collector of which a distance from the surface of the battery cell case is smaller than a distance of the current collector having the first uncoated portion has a second uncoated portion, and the second uncoated portion extends to outside of the battery cell case, thereby forming a second exposed portion.

5. The battery cell of claim 4, wherein the battery cell has, inside the battery cell case, a site at which the first uncoated portion and the second uncoated portion are joined.

6. The battery cell of claim 4, wherein a thickness of the first uncoated portion is greater than a thickness of the second uncoated portion.

7. A battery module, comprising:
the battery cell of claim 1; and
at least one of a condenser or a battery module case,
wherein the first exposed portion is joined to at least one of the condenser or the battery module case in an electrically insulating manner.
